(19) United States
(12) Patent Application Publication
(10) Pub. No.: US 2008/0074249 A1
(43) Pub. Date: Mar. 27, 2008

(54) Wireless tire pressure detection device

(75) Inventors: Ling-Ho Cheng, Taipei City (TW); Chia-Yi Wang, Taipei City (TW); Shu-Mei Kuo, Taipei City (TW)

Correspondence Address: Troxell Law Office Pllc, Suite 1404, 5205 Leesburg Pike, Falls Church, VA, 22041, US

(73) Assignee: Chia-Yi WANG & Shu-Mei KUO & Tsai-Yu LEE

(21) Appl. No.: 11/526,234

(22) Filed: Sep. 25, 2006

(51) Int. Cl. B60C 23/00

(52) U.S. Cl. 340/445

(57) ABSTRACT

A tire pressure detection device is composed of a housing, a washer, an air valve, and a lead-wire antenna. The tire pressure detection device can be installed in an interior side of a tire to detect the tire pressure and temperature in time. In addition, this kind of information is transmitted to a receiver for determination, through the lead-wire antenna. The air valve is provided with a dual function of the transmission antenna and the air valve of tire, and the tire pressure detection device is integrated into one body by using an injection molding method. Furthermore, the tire pressure detection device can be replaced for a different rim, so as to achieve an all-round installation.

### BACKGROUND OF THE INVENTION

(a) Field of the Invention

The present invention relates to a wireless tire pressure detection device, and more particularly to a wireless tire pressure detection device which is integrated with a vehicle into one body by using an injection molding method.

(b) Description of the Prior Art

Referring to FIG. 1, it shows a perspective view of a conventional tire pressure gauge A. To proceed with a tire pressure measurement, an air inlet A1 should be first accurately inserted into an air valve of a tire, to allow air expelled from the air valve to be filled into the tire pressure gauge A. By observing a change of observation rod A2, in association with scales A3 on the observation rod A2, one can determine whether the tire pressure is normal, which will cause an inconvenience in the measurement, require a manpower to proceed with the measurement, and easily cause an incorrect reading in a manual measurement such that an insufficiency of the tire pressure is not detected, so as to easily cause a danger in driving.

Accordingly, how to eliminate the aforementioned drawbacks is a technical issue to be solved by the inventor of present invention.

### SUMMARY OF THE INVENTION

The present invention is to provide a wireless tire pressure detection device, especially a wireless tire pressure detection device which is integrated with a vehicle into one body by using an injection molding method, and can be used to replace an original air valve to inflate and deflate a tire. Therefore, the present invention is provided with both functions of the air valve of tire and of the tire condition detection, and can be effectively and firmly installed on the tire.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a conventional tire pressure gauge.

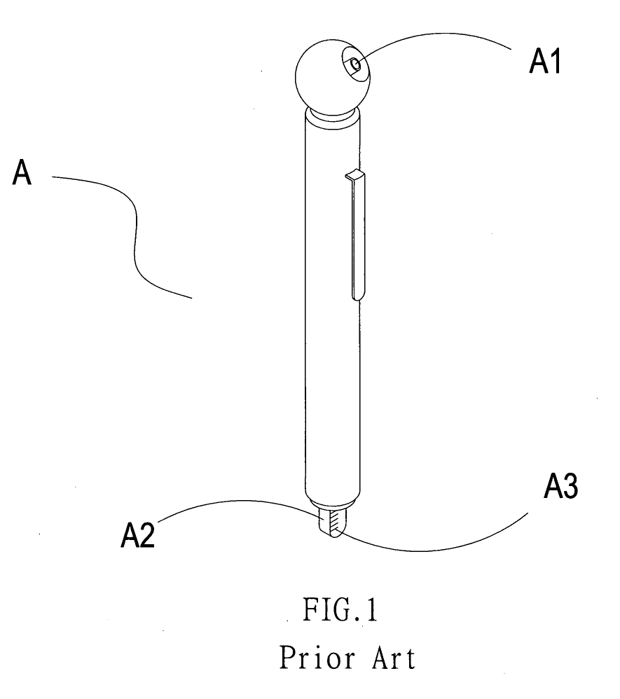

FIG. 2 shows a perspective view of the present invention.

FIG. 3 shows an exploded view of the present invention.

FIG. 4 shows a first schematic view of an embodiment of the present invention.

FIG. 5 shows a second schematic view of an embodiment of the present invention.

FIG. 6 shows a third schematic view of an embodiment of the present invention.

FIG. 7 shows a fourth schematic view of an embodiment of the present invention.

FIG. 8 shows a fifth schematic view of an embodiment of the present invention.

### DETAILED DESCRIPTION OF THE PREFERRED EMBODIMENTS

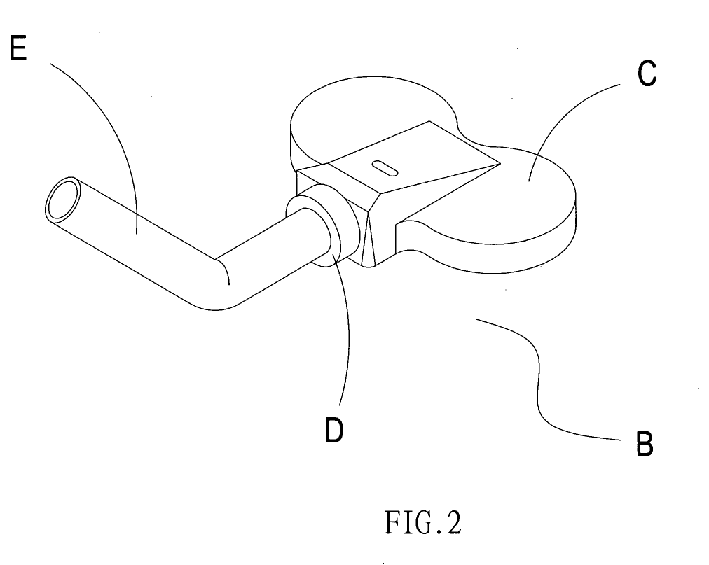

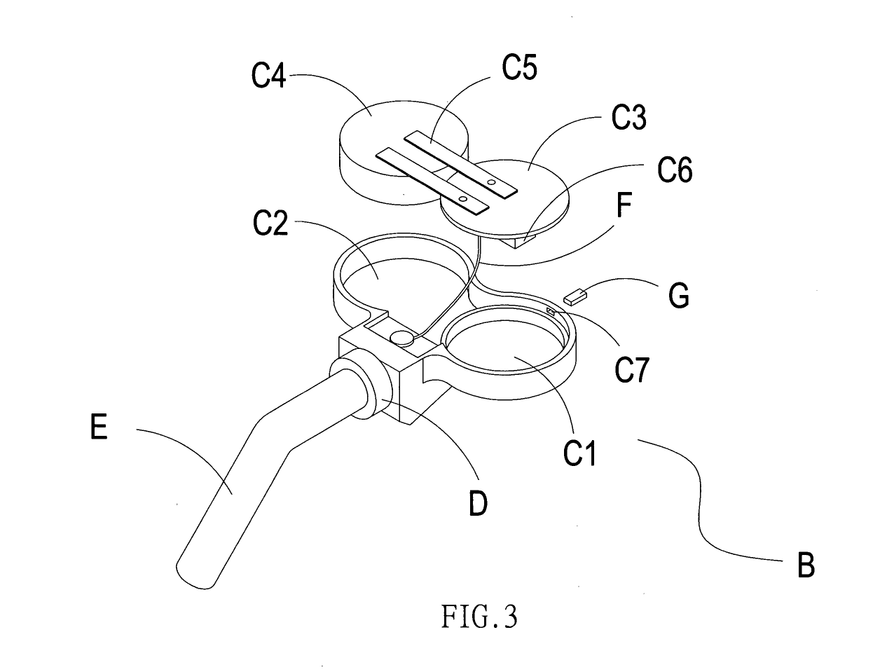

Referring to FIG. 2 and FIG. 3, the present invention is to provide a wireless tire pressure detection device B, which comprises a housing C, a washer D, an air valve E, and a lead-wire antenna F. An interior of the housing C is provided with a first chamber C1 and a second chamber C2, the first chamber C1 and the second chamber C2 are installed with a circuit board C3 and a power supply element C4 respectively, and the circuit board C4 is interconnected with the power supply element C3 with spring leaves C5.

The circuit board C3 is provided with a sensor element C6 which is connected to the air valve E through the lead-wire antenna F to enhance a signal intensity emitted by the air valve E. The air valve E is extended with the washer D which enables the air valve E to be firmly fixed on the housing C and is provided with functions of leak-proof, slid-proof, and insulation in a tire. The air valve E can be also used as a fixing rack, enabling the detection device B to be more firmly fixed in the tire.

A side of the first chamber C1 of housing C is provided with a hole C7 for inserting a pin G which is corresponding to the circuit board C3. When the pin G is inserted, the circuit board C3 will not function, whereas when the pin G is removed, the circuit board C3 is in a normal conduction state to achieve a function of power saving.

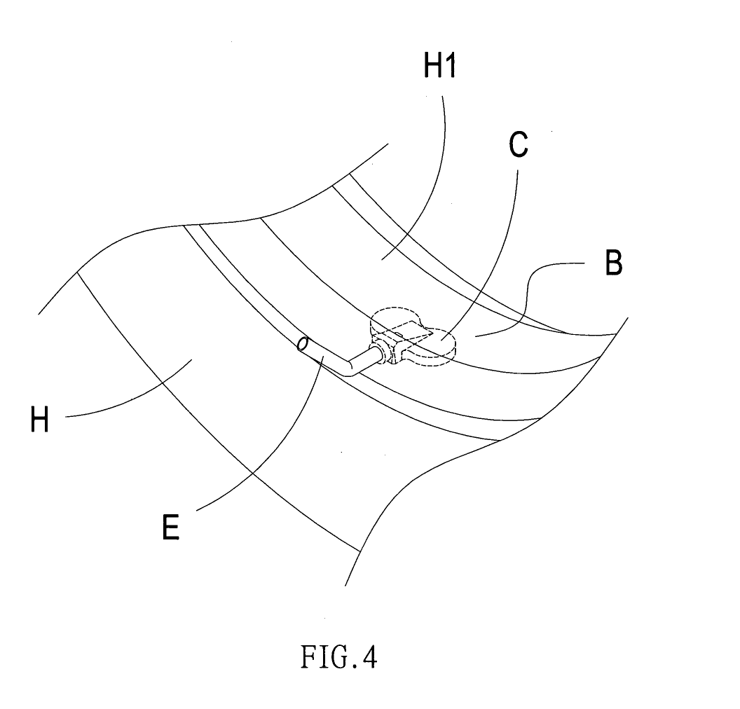

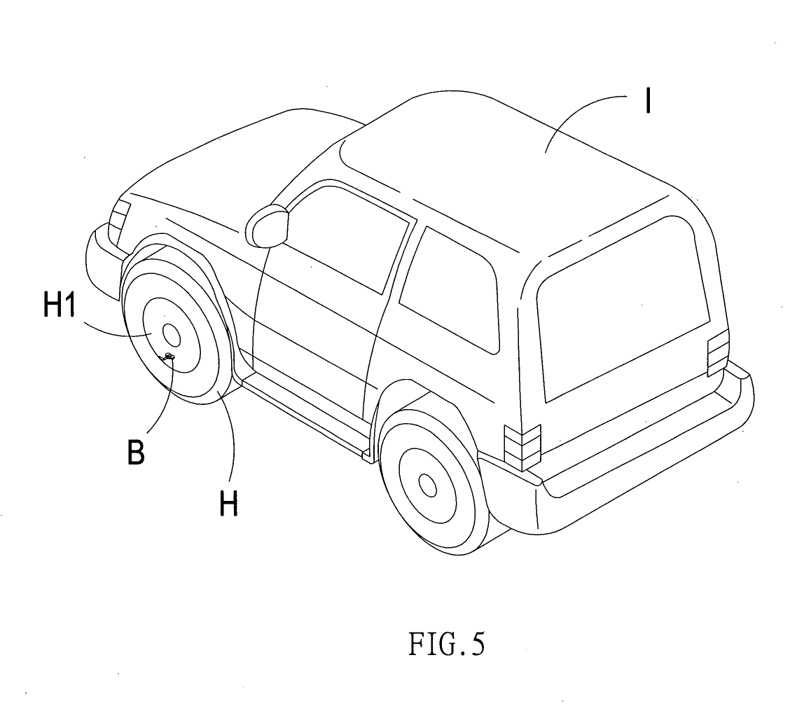

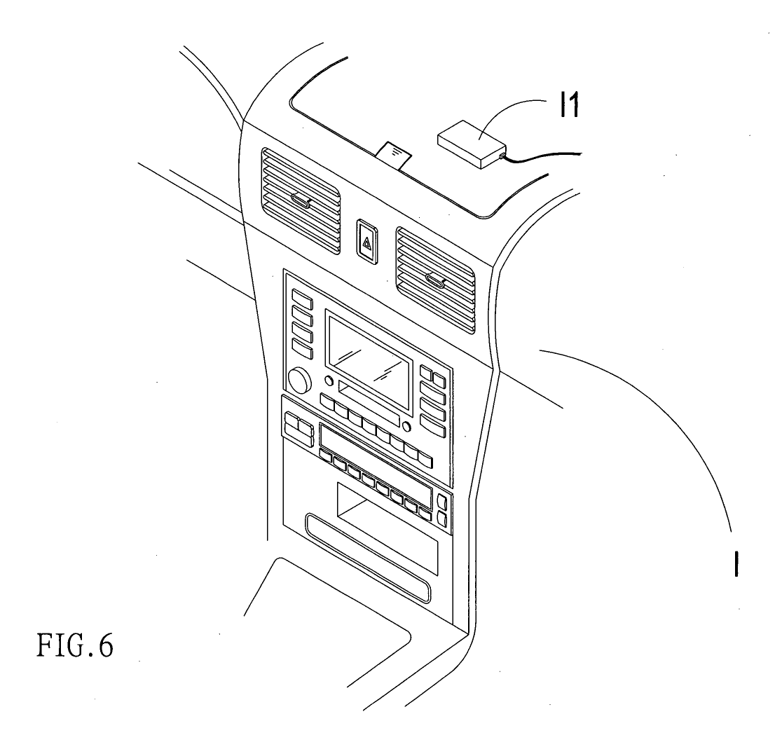

Referring to FIGS. 4 to 6, a tire pressure detection device B is installed on a rim H1 of tire H, and is integrated with the rim H1 into one body by using an injection molding method. The tire pressure detection device B is provided with a washer D which can achieve functions of leak-proof, slid-proof, and insulation on the rim H1. The washer D can be also used to fix an air valve E on a housing C, in association with the injection molding method, and the air valve E of different design can be replaced for the rim H1 of different specification. In addition, an angle of the air valve E with respect to the housing C can be adjusted by using a molding tool. A signal generated by the air valve E is transmitted to a signal receiving device 11 which is installed in a vehicle 1, such that when a user is driving, he or she can be aware of a condition of tire H of the vehicle 1, through the signal receiving device 11 in the vehicle 1, in order to prevent a danger of flat tire from an insufficient tire pressure or an excessively high temperature of the tire H.

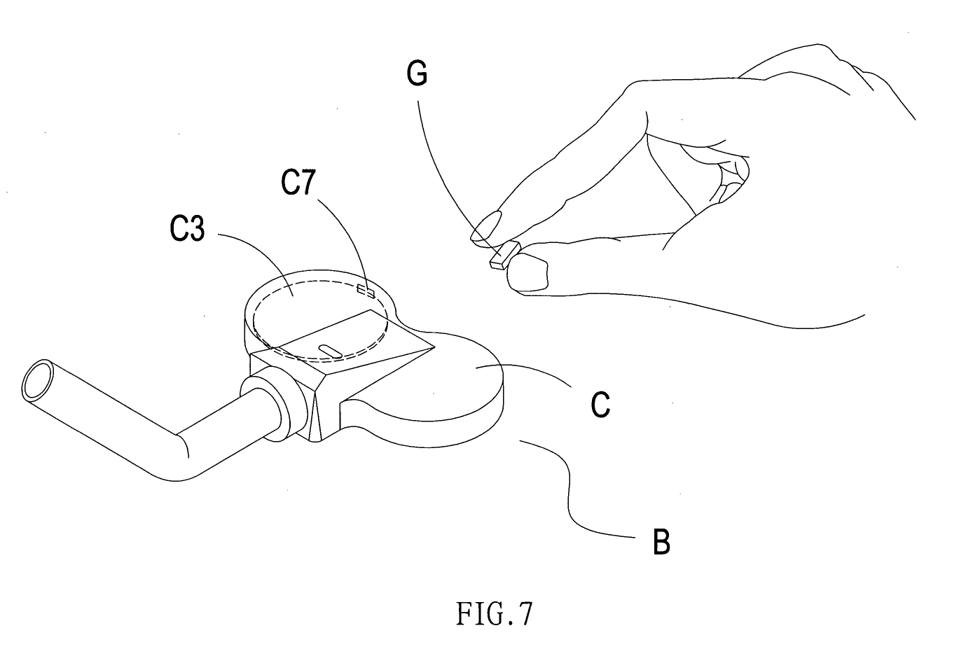

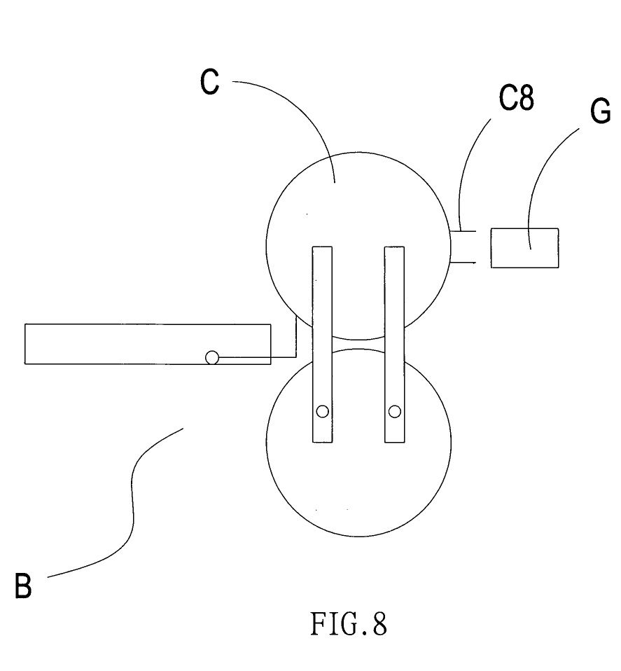

Referring to FIG. 7 and FIG. 8, a side of the housing C is provided with a hole C7 which is corresponding to a location of circuit board C3 having a power switch C8. If the tire pressure detection device B is not used, a pin G can be inserted into power switch C8 through the hole C7 to break the circuit; on the contrary, in order to enable the tire pressure detection device B to function as a normal detection purpose, the pin G is pulled out to activate the circuit board C3, such that an effect of power saving is achieved when the tire pressure detection device B is not used.

To further manifest the advancement and practicability of the present invention, the present invention is compared with a conventional tire pressure gauge as below:

Shortcomings of a Conventional Tire Pressure Gauge
1. The tire pressure should be measured manually with the tire pressure detection device.
2. It is easy to cause an incorrect measurement reading.
3. It will waste a manpower and time.

Advantages of the Present Invention
1. The tire pressure and temperature can be automatically detected with the tire pressure detection device.
2. The air valve can be used to replace the functions of inflating and deflating the tire, and can also achieve a performance of a fixing rack.
3. The condition of tire can be accurately detected.
4. It can save a manpower and time.
5. It is provided with the advancement and practicability.
6. It is provided with an industrial competitiveness.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A wireless tire pressure detection device comprising a housing, a side of which is provided with a power supply element for supplying the power, and the other side of which is provided with a circuit board, with spring leaves being extended between the circuit board and the power supply element, and with a sensor element being installed on the circuit board; a washer, a side of which is extended to the housing, which is provided with a groove, and which achieves functions of leak-proof, slid-proof, and insulation; and a lead-wire antenna, which is used to emit signals, and a side of which is extended to an air valve for enhancing a signal intensity to be emitted; the tire pressure and temperature being detected by the sensor element, and the signals being transmitted through the lead-wire antenna which is connected to the air valve for enhancing the signal intensity to be emitted; the air valve achieving functions of inflating and deflating the tire, such that when the tire pressure detection device is installed in the tire, the tire pressure detection device is provided with a dual function of the air valve of tire and the detection of tire condition, and is firmly fixed in the tire.

2. The wireless tire pressure detection device according to claim 1, wherein the circuit board includes a pin, such that a functioning of the circuit board is controlled by inserting and pulling the pin.

3. The wireless tire pressure detection device according to claim 1, wherein the air valve and the lead-wire antenna are further made by an ordinary aluminum alloy, gold, iron, copper, or any material which is used to produce the antenna and air valve.

4. The wireless tire pressure detection device according to claim 1, wherein the different air valve is replaced for the rim of different specification and an angle of the air valve is adjusted by using a molding tool.

5. The wireless tire pressure detection device according to claim 1, wherein the signals generated by the air valve are transmitted to a signal receiving device which is further installed on a vehicle.

6. The wireless tire pressure detection device according to claim 1, wherein two sides of the circuit board are further coated with elastic water-proof glue which increases a tight binding between the housing and the circuit board, and prevents from resulting in cracks.
